(19) United States
(12) Patent Application Publication
(10) Pub. No.: US 2005/0117083 A1
(43) Pub. Date: Jun. 2, 2005

(54) Thin film diode panel and manufacturing method of the same

(76) Inventors: Joon-Hak Oh, Seoul (KR); Jin-Hong Kim, Seoul (KR); Sung-Jin Hong, Seoul (KR); Mun-Pyo Hong, Seongnam-si (KR); Kyong-Ju Shin, Yongin-si (KR); Chong-Chul Chai, Seoul (KR)

Correspondence Address: CANTOR COLBURN, LLP, 55 GRIFFIN ROAD SOUTH, BLOOMFIELD, CT, 06002, US

(21) Appl. No.: 10/977,987

(22) Filed: Oct. 29, 2004

(30) Foreign Application Priority Data
Oct. 29, 2003 (KR) 10-2003-0075871

(51) Int. Cl. G02F 1/136

(52) U.S. Cl. 349/51

(57) ABSTRACT

The present invention provides a liquid crystal display comprising: an insulating substrate; a plurality of color filters formed on the insulating substrate; a plurality of first and second gate lines formed on the color filters; a plurality of pixel electrodes formed on the color filters; a plurality of first MIM diodes formed on the color filters and connecting the first gate line and the pixel electrodes; and a plurality of second MIM diodes formed on the color filters and connecting the second gate line and the pixel electrodes.

### BACKGROUND OF THE INVENTION

(a) Field of the Invention

The present disclosure relates to thin film diode array panels using metal insulator metal (MIM) diodes as switching elements, and a manufacturing method of the same. In more detail, the present disclosure relates to thin film diode array panels of a dual select diode (DSD) type, and a liquid crystal display using the same.

(b) Description of the Related Art

A liquid crystal display (LCD) is one of the most widely used flat panel displays. An LCD includes two panels provided with field-generating electrodes, and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

An LCD may have switching elements to switch voltages of pixels arranged in a matrix form. An LCD can display various images since pixel voltages are individually switched. An LCD having switching elements to switch pixel voltages individually is called an active matrix LCD.

Thin film transistors or thin film diodes may be used as the switching elements. When thin film diodes are applied, MIM diodes can be used.

A MIM diode has two metal layers and one insulating layer interposed between the metal layers, and a thickness capable of being measured in micrometers. A MIM diode may act as a switch due to electrical non-linearity of the insulating layer. A MIM diode has two terminals, and as a result, the manufacturing process of the MIM diode is simpler than that of the thin film transistor having three terminals. Accordingly, MIM diodes can be manufactured at a lower cost than thin film transistors.

However, when diodes are used as switching elements, the uniformity of image quality and contrast ratio may be degraded due to asymmetry of an applied voltage with respect to the polarity.

In response to the asymmetry, a dual select diode (DSD) panel has been developed. A DSD panel includes two diodes that are symmetrically connected to a pixel electrode and are driven by applying voltages of opposite polarities.

A DSD LCD shows improved image quality, contrast ratio, gray scale uniformity, and response speed by applying voltages having opposite polarities to two diodes that are connected to the same pixel electrode. Accordingly, a DSD LCD can display images with high resolution like that of an LCD using thin film transistors.

A thin film diode array panel of a conventional DSD LCD has transmission electrodes made of a transparent conductor such as indium tin oxide (ITO) formed on a substrate as a bottom layer, and signal lines made of a metal and formed on the other layers as a top layer.

Hence, such a conventional thin film diode array panel structure has the following demerit.

Off current (loff) of a MIM diode is increased because back light reaches the silicone-rich silicon nitride (Si-rich SiNx) layer that forms a channel of the MIM diode, and activates the Si-rich SiNx layer. To solve such a problem, the back light unit is disposed on the color filter panel side and displayed images are seen in front of the thin film diode panel. However, this method also has problems such that characteristics of MIM diodes are affected by external light, and the contrast ratio is degraded due to light reflections by the metal signal lines.

### SUMMARY OF THE INVENTION

It is an object of the present invention to provide an DSD LCD without such a problem.

The present invention provides a liquid crystal display comprising: an insulating substrate; a plurality of color filters formed on the insulating substrate; a plurality of first and second gate lines formed on the color filters; a plurality of pixel electrodes formed on the color filters; a plurality of first MIM diodes formed on the color filters and connecting the first gate line and the pixel electrodes; and a plurality of second MIM diodes formed on the color filters and connecting the second gate line and the pixel electrodes.

Here, the liquid crystal display may further comprise a black matrix formed between the insulating substrate and the color filters wherein the black matrix includes at least a portion overlapping the first and second MIM diodes, and the black matrix is made of a material mainly including an organic material.

The color filters may include red, green, and blue color filters and overlap each other at a part wherein the overlapping area of the color filters includes at least a portion overlapping the first and second MIM diodes.

The liquid crystal display may further comprises an inter-insulating layer formed between the first and second gate lines and the pixel electrodes, wherein the inter-insulating layer is made of an organic insulating material.

The first MIM diode may include a first input electrode connected to the first gate line, a first contact portion connected to the pixel electrode, a channel insulating layer formed on the first input electrode and the first contact portion, and a first floating electrode formed on the channel insulating layer and intersecting the first input electrode and the first contact portion; and the second MIM diode may include a second input electrode connected to the second gate line, a second contact portion connected to the pixel electrode, the channel insulating layer formed on the second input electrode and the second contact portion, and a second floating electrode formed on the channel insulating layer and intersecting the second input electrode and the second contact portion.

The liquid crystal display is manufactured by a method comprising: forming a plurality of color filters on an insulating substrate; forming an inter-insulating layer on the color filters; forming a plurality of first and second gate lines and pixel electrodes on the inter-insulating layer; forming a channel insulating layer on the first and second gate lines and pixel electrodes; and forming a plurality of first and second floating electrodes on the channel insulating layer.

The manufacturing method of a liquid crystal display may further comprise forming a black matrix before the step of forming color filters.

### BRIEF DESCRIPTION OF THE DRAWINGS

Preferred embodiments of the present invention can be understood in more detail from the following descriptions taken in conjunction with the accompanying drawings, in which:

FIG. 1 is a perspective view of a liquid crystal display according to an embodiment of the present invention;

FIG. 2 is a layout view of a liquid crystal display according to an embodiment of the present invention;

FIG. 3 is a sectional view of the liquid crystal display taken along the line III-III′ of FIG. 2; and

FIG. 4 is a sectional view of a liquid crystal according to another embodiment of the present invention.

### DETAILED DESCRIPTION OF THE PREFERRED EMBODIMENTS

Preferred embodiments of the present invention will now be described more fully hereinafter with reference to the accompanying drawings, in which preferred embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

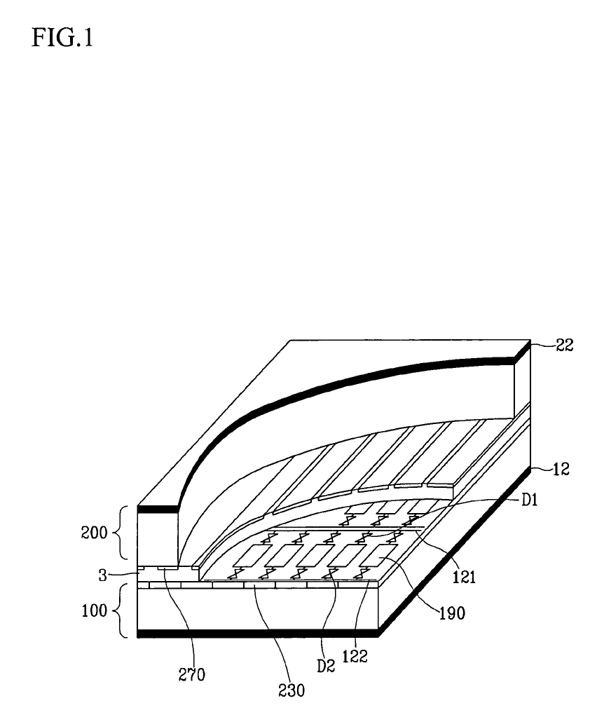

FIG. 1 is a perspective view of a liquid crystal display according to an embodiment of the present invention.

As shown in FIG. 1, the liquid crystal display has a lower panel (a thin film diode array panel) 100, an upper panel (a color filter array panel) 200 facing the lower panel 100, and a liquid crystal layer 3 interposed between the two panels 100 and 200 and having liquid crystal molecules aligned in a horizontal direction with respect to the surfaces of the panels 100 and 200.

The lower panel 100 has a plurality of red, green, and blue color filters 230, and a plurality of pixel electrodes 190 which respectively correspond with the red, green, and blue color filters 230. White pixel areas on which no color filter is formed may also be included. The lower panel 100 has a plurality of pairs of gate lines 121 and 122 transmitting signals having opposite polarities, and a plurality of MIM diodes D1 and D2 that are switching elements.

The upper panel 200 includes a plurality of data electrode lines 230, forming an electric field along with the pixel electrodes 190 for driving liquid crystal molecules and defining pixel regions by intersecting the pairs of gate lines 121 and 122.

Henceforth, a structure of a liquid crystal display according to an embodiment of the present invention will be described in detail.

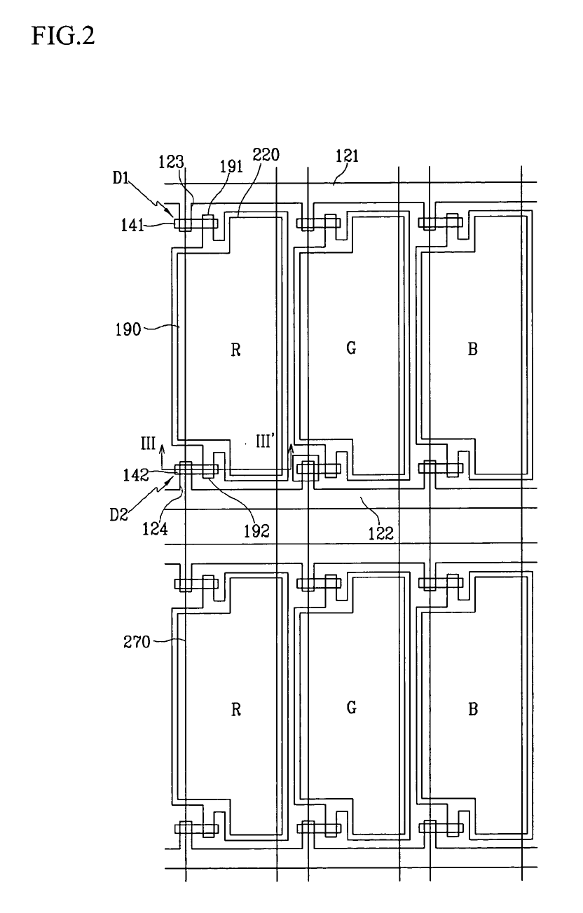

FIG. 2 is a layout view of a liquid crystal display according to an embodiment of the present invention.

Referring to FIG. 2, the liquid crystal display has a plurality of red, green, and blue pixels R, G, and B that are arranged in a matrix form. A pixel column consists of the same colored pixels. For example, red pixels R, green pixels G, and blue pixels B are sequentially and alternately arranged along a pixel row, but a pixel column only includes one color of the red, green, and blue pixels. That is, each color of the red, green, and blue pixels R, G, and B forms a stripe. However, the arrangement of the red, green, and blue pixels R, G, and B may have various modifications. White pixels may be included.

In the above described LCD, a set of the red, green, and blue pixels forms a dot which is a basic unit of images. The size of each pixel is uniform.

Henceforth, a structure of a thin film diode array panel 100 according to an embodiment of the present invention will be described in detail.

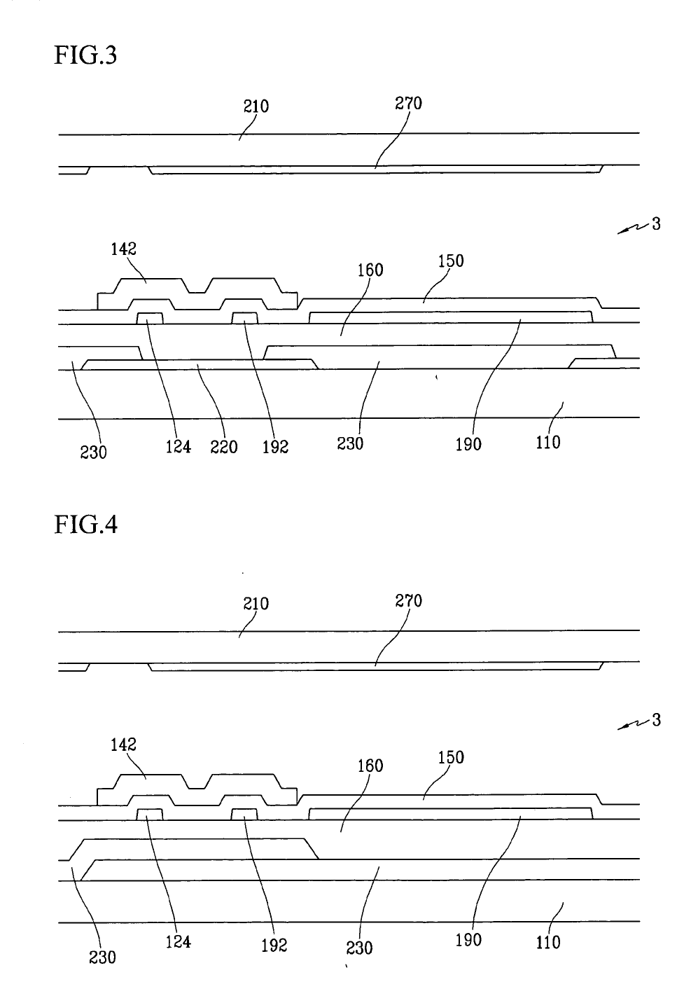

FIG. 3 is a sectional view of the liquid crystal display taken along the line III-III′ of FIG. 2;

As shown in FIGS. 2 and 3, a black matrix 220 formed of a chromium (Cr) single layer or Cr and chromium oxide (CrO₂) double layers is formed on the insulating substrate 110. The black matrix 220 may be formed of an organic material. When the black matrix 220 is made of an organic material, the stress that the substrate 210 receives is reduced. An organic black matrix is useful for a flexible display.

The black matrix 220 is disposed under the MIM diodes and the boundary of the pixels.

The red, green, and blue color filters 230 are formed on the black matrix 220 to form stripes.

An inter-insulating layer 160 made of an organic material is formed on the color filters 230. The inter-insulating layer 160 may be made of an inorganic material such as silicon nitride or silicon oxide. However, it is preferable for flattening that the inter-insulating layer 160 is made of an organic material.

A plurality of pixel electrodes 190 made of a transparent conductor such as indium tin oxide (ITO) and indium zinc oxide (IZO) are formed on the inter-insulating layer 160. Each pixel electrode 190 is electrically connected to the first and second gate lines 121 and 122 which extend in a transverse direction through MIM diodes D1 and D2.

The pixel electrodes 190 may be made of a conductor having good light reflectivity such as aluminum (Al) and silver (Ag) for a reflection type of LCD.

In more detail, each pixel electrode 190 is formed in a pixel region on the inter-insulating layer 160. The pixel electrode 190 includes a first contact portion 191 and a second contact portion 192.

The first and second gate lines 121 and 122 transmitting scanning signals are respectively disposed at upper and lower sides of the pixel region on the inter-insulating layer 160. First and second input electrodes 123 and 124 respectively connected to the first and second gate lines 121 and 122 extend toward each other. The first and second input electrodes 123 and 124 are respectively adjacent to the first and second contact portions 191 and 192 of the pixel electrode 190 with a predetermined gap therebetween.

It is preferable that the first and second gate lines 121 and 122 are made of the same material as the pixel electrode 190, for simplifying manufacturing processes. However, when another purpose such as reducing resistance is more important, the first and second gate lines 121 and 122 may be made of a different material from the pixel electrode 190. In this case, the first and second gate lines 121 and 122 may be made of one of aluminum (Al), chromium (Cr), thallium (Ta), molybdenum (Mo), and their alloys.

A channel insulating layer 150 is formed on the first and second gate lines 121 and 122. A channel insulating layer 150 is made of silicon nitride (SiNx). The channel insulating layer 150 may be regionally formed on the first input electrode 123 and the first contact portion 191 and the second input electrode 124 and the second contact portion 192.

A first floating electrodes 141 is formed on the channel insulating layer 150 to intersect the first input electrode 123 and the first contact portion 191. A second floating electrode 142 is formed on the channel insulating layer 150 to intersect the second input electrode 124 and the second contact portion 192.

The upper panel 200 includes an insulating substrate 210 and a plurality of data electrode lines 270 formed on the insulating substrate 210. The data electrode line 270 is made of a transparent conductor such as ITO and IZO. The data electrode line 270 overlaps the pixel electrodes 190 and a liquid crystal layer 3 is interposed between the data electrode line 270 and the pixel electrodes 190 to form liquid crystal capacitors.

The first floating electrode 141, the first input electrode 123, the first contact portion 191, and the channel insulating layer 150 interposed between them form a first MIM diode D1. The second floating electrode 142, the second input electrode 124, the second contact portion 192, and the channel insulating layer 150 interposed between them form a second MIM diode D2.

Due to the nonlinearity of voltage-current characteristics of the channel insulating layer 150, the first and second MIM diodes D1 and D2 permit the pixel electrode 190 to be charged only when a voltage over the critical voltage of the channel insulating layer 150 is applied. On the contrary, when no signal voltage is applied to the MIM diodes D1 and D2, the charged voltage is preserved in a liquid crystal capacitor formed between the pixel electrode 190 and a data electrode line 270, since the channel of the MIM diodes M1 and M2 are closed.

When an LCD is manufactured to have the above-described structure, even though a back light is disposed under the thin film diode panel 100, the light of the back light does not reach the channel insulating layer 150 due to interception of the black matrix 220. As a result, off current (loff) of the MIM diodes is not increased.

Since the color filters 230 are formed on the same substrate 110 with the pixel electrode 190, the alignment step for assembling the upper and lower panels 100 and 200 is easy. Further, the width of the black matrix 220 that has redundancy for covering misalignment of the upper and lower panels 100 and 200 can be reduced to enhance the aperture ratio of an LCD.

Henceforth, a manufacturing method of a thin film diode array panel according to an embodiment of the present invention will be described with reference to FIG. 3.

One of the Cr single layer, the Cr and CrO₂ double layers, and a black organic thin film is deposited on the insulating substrate 110 and is photo-etched to form the black matrix 220.

When the black matrix 220 is made of a photosensitive organic material, the black matrix 220 may be formed by an exposure and development process.

Next, a photoresist including red pigments is coated, exposed to a light, and developed to form the red color filter 230. The same processes are performed to photoresists respectively including green and blue pigments to form the green and blue color filters.

One of an organic insulating material, silicon nitride, and silicon oxide is deposited to form the inter-insulating layer 160.

A transparent conductive layer such as indium tin oxide (ITO) and indium zinc oxide (IZO) is deposited on the inter-insulating layer 160 and is photo-etched to form the first and second gate lines 121 and 122 and the pixel electrode 190.

When the pixel electrode 190 is formed of a different material from the first and second gate lines 121 and 122, the pixel electrode 190 is patterned by a separate photo-etching process from that of the first and second gate lines 121 and 122.

When a thin film diode array panel for a reflection type of LCD is manufactured, the first and second gate lines 121 and 122 and the pixel electrode 190 may be formed of a conductor having good light reflectivity such as aluminum (Al) or silver (Ag).

Silicon nitride is deposited on the first and second gate lines 121 and 122 and the pixel electrode 190 to form the channel insulating layer 150. The channel insulating layer 150 may be photo-etched to form regional channel insulating layers disposed on the first input electrode 123 and the first contact portion 191 and the second input electrode 124 and the second contact portion 192.

A metal such as Mo is deposited and photo-etched to form the first and second floating electrodes 141 and 142.

Henceforth, another embodiment of the present invention will be described.

FIG. 4 is a sectional view of a liquid crystal display according to another embodiment of the present invention.

The LCD of FIG. 4 will be compared with the LCD of FIGS. 2 and 3, and only differences that are peculiar to the LCD of FIG. 4 will be described.

The LCD of FIG. 4 has color filters 230 formed directly on an insulating substrate 110 without a black matrix.

The color filters 230 overlap each other at adjacent parts thereof. Almost no light transmits through the overlapping areas of the color filters 230 due to light absorption of the color filters 230. Accordingly, the overlapping areas of the color filters 230 play a role of a black matrix.

The most peculiar thing of the LCD of FIG. 4 is that the black matrix 220 of the LCD of FIGS. 2 and 3 is replaced with the overlapping area of the color filters 230.

The thin film transistor array panel of FIG. 4 may be manufactured by omitting formation of the black matrix from the manufacturing method of the thin film diode array panel of FIGS. 2 and 3, and forming color filters 230 to partially overlap each other.

When a thin film diode panel for an LCD is manufactured to have the structure of FIG. 4, the process of forming the black matrix can be omitted to simplify the manufacturing method.

When an LCD is manufactured to have the above-described structures, even though a back light is disposed under the thin film diode panel 100, the light of the back light does not reach the channel insulating layer 150 due to interception of the black matrix 220 or the overlapping areas of the color filters 230. As a result, off current (loff) of the MIM diodes is not increased.

Since the color filters 230 are formed on the same substrate 110 as the pixel electrode 190, work for aligning the upper and lower panels 100 and 200 can be saved.

Further, the width of the black matrix 220 that has redundancy for covering misalignment of the upper and lower panel 100 and 200 can be reduced to enhance the aperture ratio of an LCD.

Although illustrative embodiments have been described herein with reference to the accompanying drawings, it is to be understood that the present invention is not limited to those precise embodiments, and that various changes and modifications may be affected therein by one of ordinary skill in the related art without departing from the scope or spirit of the invention. All such changes and modifications are intended to be included within the scope of the invention as defined by the appended claims.

1. A liquid crystal display comprising:
an insulating substrate;
a plurality of color filters formed on the insulating substrate;
a plurality of first and second gate lines formed on the color filters;
a plurality of pixel electrodes formed on the color filters;
a plurality of first MIM diodes formed on the color filters and connecting the first gate lines and the pixel electrodes; and
a plurality of second MIM diodes formed on the color filters and connecting the second gate lines and the pixel electrodes.

2. The liquid crystal display of claim 1, further comprising a black matrix formed between the insulating substrate and the color filters.

3. The liquid crystal display of claim 2, wherein the black matrix includes at least a portion overlapping the first and second MIM diodes.

4. The liquid crystal display of claim 2, wherein the black matrix is made of a material mainly including an organic material.

5. The liquid crystal display of claim 1, wherein the color filters include red, green, and blue color filters that overlap each other in part.

6. The liquid crystal display of claim 5, wherein the overlapping area of the color filters includes at least a portion overlapping the first and second MIM diodes.

7. The liquid crystal display of claim 1, further comprising an inter-insulating layer formed between the first and second gate lines and the pixel electrodes.

8. The liquid crystal display of claim 7, wherein the inter-insulating layer is made of an organic insulating material.

9. The liquid crystal display of claim 1, wherein the first MIM diode includes a first input electrode connected to the first gate line, a first contact portion connected to the pixel electrode, a channel insulating layer formed on the first input electrode and the first contact portion, and a first floating electrode formed on the channel insulating layer and intersecting the first input electrode and the first contact portion; and
the second MIM diode includes a second input electrode connected to the second gate line, a second contact portion connected to the pixel electrode, the channel insulating layer formed on the second input electrode and the second contact portion, and a second floating electrode formed on the channel insulating layer and intersecting the second input electrode and the second contact portion.

10. A manufacturing method of a liquid crystal display, comprising:
forming a plurality of color filters on an insulating substrate;
forming an inter-insulating layer on the color filters;
forming a plurality of first and second gate lines and pixel electrodes on the inter-insulating layer;
forming a channel insulating layer on the first and second gate lines and pixel electrodes; and
forming a plurality of first and second floating electrodes on the channel insulating layer.

11. The manufacturing method of the liquid crystal display of claim 10, further comprising forming a black matrix before the step of forming the color filters.
